(19) United States
(12) Patent Application Publication
(10) Pub. No.: US 2012/0118510 A1
(43) Pub. Date: May 17, 2012

(54) METHOD FOR DEBONDING COMPONENTS IN A CHAMBER

(75) Inventors: Sumanth Banda, San Jose, CA (US); Jennifer Y. Sun, Mountain View, CA (US)

(73) Assignee: APPLIED MATERIALS, INC., Santa Clara, CA (US)

(21) Appl. No.: 13/294,012

(22) Filed: Nov. 10, 2011

Related U.S. Application Data
(60) Provisional application No. 61/413,796, filed on Nov. 15, 2010.

(51) Int. Cl. B32B 38/10

(52) U.S. Cl. 156/704; 156/714

(57) ABSTRACT

Embodiments of the invention provide a method for debonding chamber component used in a semiconductor processing chamber. In one embodiment, a method for debonding chamber components used in a semiconductor processing chamber includes providing a first chamber component and a second chamber component bonded by an adhesive material disposed at an interface defined between the first and the second chamber components, soaking the bonded first and the second chamber components into an organic solution for between about 8 hours to about 240 hours, and removing the bonded first and the second chamber from the organic solution; and mechanically separating the soaked first and the second chamber components.

### CROSS-REFERENCE TO RELATED APPLICATIONS

This application claims benefit of U.S. Provisional Application Ser. No. 61/413,796 filed Nov. 15, 2010 (Attorney Docket No. APPM/15755L), which is incorporated by reference in its entirety.

### BACKGROUND OF THE INVENTION

1. Field of the Invention

Embodiments of the invention generally relate to a semiconductor processing chamber, more specifically, to a method suitable for debonding semiconductor processing chamber components.

2. Description of the Related Art

Semiconductor processing involves a number of different chemical and physical processes whereby minute integrated circuits are created on a substrate. Layers of materials which make up the integrated circuit are created by chemical vapor deposition, physical vapor deposition, epitaxial growth, and the like. Some of the layers of material are patterned using photoresist masks and wet or dry etching techniques. The substrate utilized to form integrated circuits may be silicon, gallium arsenide, indium phosphide, glass, or any other appropriate materials.

A typical semiconductor processing chamber may have many components. Some components include a chamber body defining a process zone, a gas distribution assembly adapted to supply a process gas from a gas supply into the process zone, a gas energizer, e.g., a plasma generator, utilized to energize the process gas within the process zone, a substrate support assembly, and a gas exhaust. Some components may be comprised of an assembly of parts. For example, a showerhead assembly may include a conductive base plate adhesively bonded to a ceramic gas distribution plate. Effective bonding of the parts requires a suitable adhesive and a unique bonding technique to ensure that the parts are securely attached to each other while compensating for any mismatch in thermal expansion and without adversely creating any interfacial defects. After a number of uses of the chamber components, the chamber components are often required to be cleaned or replaced to maintain cleanliness of the processing chamber so as to prevent process contaminations. During the cleaning or replacement processes, bonded chamber components are often to be debonded or separated for various reasons, such as cleaning, refurbishment, and so on. Separation of the bonded chamber components often result in at least one of the debonded components being damaged at the separation interface during the separation or debonding process, thereby resulting in only one or none of the debonded components being suitable for reuse. Scrapping of chamber components adversely increase manufacturing costs.

Therefore, there is a need for a method for debonding chamber components in a semiconductor processing chamber without adversely damaging the debonded chamber components.

### SUMMARY OF THE INVENTION

Embodiments of the invention provide a method for debonding chamber components used in a semiconductor processing chamber. In one embodiment, a method for debonding chamber components used in a semiconductor processing chamber includes providing a first chamber component and a second chamber component bonded by an adhesive material disposed at an interface defined between the first and the second chamber components, soaking the bonded first and the second chamber components into an organic solution for between about 8 hours to about 240 hours to weaken the adhesive material, and removing the bonded first and the second chamber from the organic solution; and mechanically separating the soaked first and the second chamber components.

In another embodiment, a method for debonding chamber components used in a semiconductor processing chamber includes providing a first chamber component and a second chamber component bonded by a silicone based or acrylic based adhesive material disposed at an interface defined between the first and the second chamber components, soaking the bonded first and the second chamber components in an organic solution for between about 8 hours to about 240 hours, softening the silicone based or acrylic based adhesive layer disposed between the first and the second chamber components, removing the bonded first and the second chamber from the organic solution, and mechanically separating the soaked first and the second chamber component.

In yet another embodiment, a method for debonding chamber components used in a semiconductor processing chamber includes providing a first chamber component and a second chamber component bonded by a silicone based or acrylic based adhesive material disposed at an interface defined between the first and the second chamber components, soaking the bonded first and the second chamber components in an organic solution for between about 8 hours to about 240 hours, softening the silicone based or acrylic based adhesive layer disposed between the first and the second chamber components, removing the bonded first and the second chamber from the organic solution selected from at least one of toluene containing solution, xylene containing solution, mixtures thereof, or acetone, and mechanically separating the soaked first and the second chamber component.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings.

FIG. 1 depicts a sectional view of one embodiment of a processing chamber using a bonding material according the present invention;

FIG. 2 depicts a process flow of debonding chamber components according to one embodiment of the present invention; and

FIG. 3 depicts a sectional view of one embodiment with substrates to be debonded by a feeler gauge according the present invention.

It is to be noted, however, that the appended drawings illustrate only typical embodiments of this invention and are therefore not to be considered limiting of its scope, for the invention may admit to other equally effective embodiments.

To facilitate understanding, identical reference numerals have been used, wherever possible, to designate identical elements that are common to the figures. It is contemplated that elements of one embodiment may be advantageously utilized in other embodiments without further recitation.

### DETAILED DESCRIPTION

Embodiments of the invention provide a method for debonding bonded chamber components utilized in a semiconductor processing chamber. In one embodiment, the bonded chamber components may be debonded by soaking the bonded chamber components in an organic solution for a predetermined time period so as to soften a bonding material disposed at the bonding interface between the bonded chamber components. As the bonding material is softened, the bonded interface is weakened so that the bonded chamber components may be separated by suitable mechanical techniques.

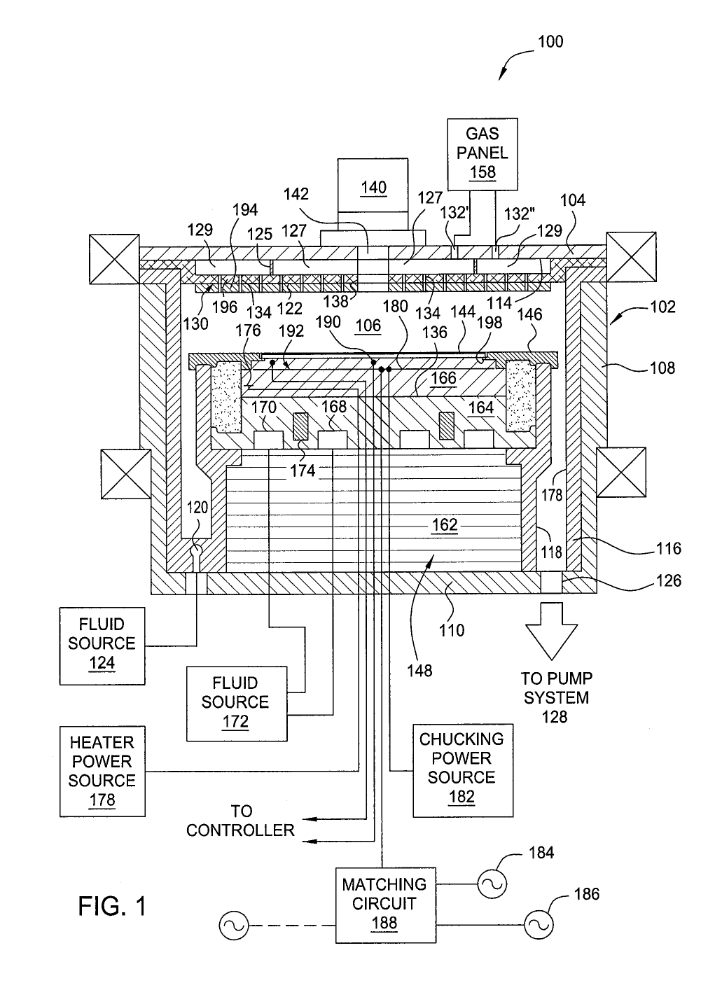

FIG. 1 is a sectional view of one embodiment of a semiconductor processing chamber 100 having at least one component utilizing a bonding material according to the present invention. One examples of suitable processing chamber 100 may be a CENTURA® ENABLER™ Etch System, available from Applied Materials, Inc of Santa Clara, Calif. It is contemplated that the other processing chambers may be adapted to benefit from one or more of the inventive techniques disclosed herein.

The processing chamber 100 includes a chamber body 102 and a lid 104 which enclose an interior volume 106. The chamber body 102 generally includes sidewalls 108 and a bottom 110. A substrate access port (not shown) is generally defined in a side wall 108 and a selectively sealed by a slit valve to facilitate entry and egress of the substrate 144 from the processing chamber 100.

An exhaust port 126 is defined in the chamber body 102 and couples the interior volume 106 to a pump system 128. The pump system 128 generally includes one or more pumps and throttle valves utilized to evacuate and regulate the pressure of the interior volume 106 of the processing chamber 100. In one embodiment, the pump system 128 maintains the pressure inside the interior volume 106 at operating pressures typically between about 10 mTorr to about 20 Torr.

The lid 104 is sealingly supported on the side wall 108 of the chamber body 102. The lid 104 may be opened to allow excess to the interior volume 106 of the processing chamber 100. The lid 104 optionally includes a window 142 that facilitates optical process monitoring. In one embodiment, the window 142 is comprised of quartz or other suitable material that is transmissive to a signal utilized by an optical monitoring system 140. One optical monitoring system that may be adapted to benefit from the invention is the EyeD® full-spectrum, interferometric metrology module, available from Applied Materials, Inc., of Santa Clara, Calif.

A gas panel 158 is coupled to the processing chamber 100 to provide process and/or cleaning gases to the interior volume 106. Examples of processing gases may include halogen-containing gas, such as C₂F₆, SF₆, SiCl₄, HBr, NF₃, CF₄, Cl₂, CHF₃, CF₄, and SiF₄, among others, and other gases such as O₂, or N₂O. Examples of carrier gases include N₂, He, Ar, other gases inert to the process and non-reactive gases. In the embodiment depicted in FIG. 1, inlet ports 132′, 132″ are provided in the lid 104 to allow gases to be delivered from the gas panel 158 to the interior volume 106 of the processing chamber 100.

A gas distribution assembly 130 is coupled to an interior surface 114 of the lid 104. The gas distribution assembly 130 includes a gas distribution plate 194 coupled to a conductive base plate 196 having a plurality of apertures 134 formed therethrough. The conductive base plate 196 may be RF powered to server as an electrode to drive a plasma process performed in the interior volume 106. The conductive base plate 196 may be bonded to the gas distribution plate 194 by an adhesive material 122. In one embodiment, the conductive base plate 196 may be fabricated by aluminum, stainless steel or other suitable materials. The gas distribution plate 194 may be fabricated from a ceramic material, such as silicon carbide, bulk Yttrium or oxide thereof to provide resistance to halogen-containing chemistries. Alternatively, the gas distribution plate 194 may be coated with Yttrium or an oxide thereof to extend the life time of the gas distribution assembly 130. The gas distribution plate 194 may be a flat disc having the plurality of apertures 134 exiting in the lower surface of the gas distribution plate 194 facing toward the substrate 144. The apertures 134 allow the gases to flow from at least one plenum defined between the gas distribution assembly 130 and chamber lid 104 into the interior volume 106 of the processing chamber 100 in a predefined distribution across the surface of the substrate 144 being processed in the processing chamber 100. In the embodiment depicted in FIG. 1, the apertures 134 allow the gases to flow from inlet ports 132′, 132″ (collectively inlet ports 132) through an inner plenum 127 and outer plenum 129 into the interior volume 106 of the processing chamber 100.

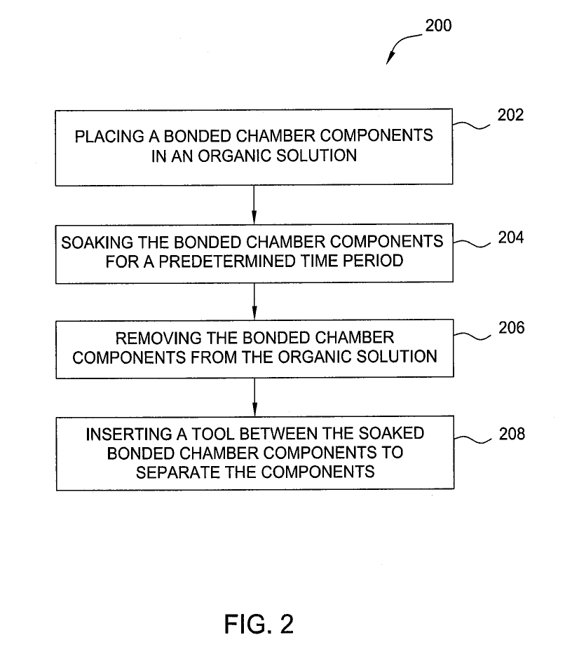

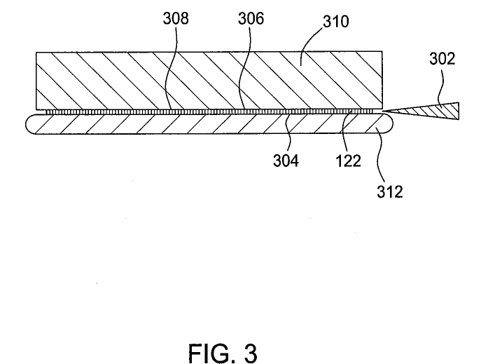

The adhesive material 122 may be applied to the lower surface of the conductive base plate 196 or the upper surface of the gas distribution plate 194 to mechanically bond the gas distribution plate 194 to the conductive base plate 196. The adhesive material 122 may also be applied in different places, such as the interface between the gas distribution assembly 130 and the chamber lid 104, or the like, to bond chamber components in the processing chamber 100. In one embodiment, the adhesive material 122 is an elastomer bonding material fabricated from silicone containing materials or acrylic based materials. As discussed above, as the bonded chamber components used in the processing chamber 100 may be required to be debonded for various reasons, a layer of adhesive material 122 used to bond chamber components may need to be weakened as needed so as to separate the chamber components bonded by the layer of adhesive material 122. A method 200 for debonding the chamber components bonded by the layer of adhesive material 122 will be further discussed below with referenced to FIGS. 2-3.

The gas distribution assembly 130 may include dividers 125 disposed between the lid 104 and the conductive base plate 196 that define an inner plenum 127 and an outer plenum 129, which are respectively fed gas by inlet ports 132′, 132″. Furthermore, the gas distribution assembly 130 may optionally include a region transmissive or passage 138 suitable for allowing the optical monitoring system 140 to view the interior volume 106 and/or substrate 144 positioned on the substrate support assembly 148. The passage 138 includes a window 142 to prevent gas leakage from the passage 138.

A substrate support assembly 148 is disposed in the interior volume 106 of the processing chamber 100 below the gas distribution assembly 130. The substrate support assembly 148 holds the substrate 144 during processing. The substrate support assembly 148 generally includes a plurality of lift pins (not shown) disposed therethrough that are configured to lift the substrate 144 from the substrate support assembly 148 and facilitate exchange of the substrate 144 with a robot (not shown) in a conventional manner.

An outer liner 116 may be positioned to protect the side walls 108 of the chamber body 102. An inner liner 118 may closely circumscribe the periphery of the substrate support assembly 148. The inner and outer liners 118, 116 may be a single component or separate components. Optionally, at least one of the inner or outer liners 118, 116 may include a conduit 120 coupled to a fluid source 124 that provides a heat transfer fluid that is circulated in the conduit for controlling the temperature of the liner.

In one embodiment, the substrate support assembly 148 includes a mounting plate 162, a base 164 and an electrostatic chuck 166. The mounting plate 162 is coupled to the bottom 110 of the chamber body 102 includes passages for routing utilities, such as fluids, power lines and sensor leads, among other, to the base 164 and chuck 166.

At least one of the base 164 or chuck 166 may include at least one optional embedded heater 176, at least one optional embedded isolator 174 and a plurality of conduits 168, 170 to control the lateral temperature profile of the substrate support assembly 148. The conduits 168, 170 are fluidly coupled to a fluid source 172 that circulates a temperature regulating fluid therethrough. The heater 176 is regulated by a power source 178. The conduits 168, 170 and heater 176 are utilized to control the temperature of the base 164, thereby heating and/or cooling the electrostatic chuck 166. The temperature of the electrostatic chuck 166 and the base 164 may be monitored using a plurality of temperature sensors 190, 192. The electrostatic chuck 166 may further comprise a plurality of gas passages (not shown), such as grooves, that are formed in a substrate supporting surface of the chuck 166 and fluidly coupled to a source of a heat transfer (or backside) gas, such as He. In operation, the backside gas is provided at controlled pressure into the gas passages to enhance the heat transfer between the electrostatic chuck 166 and the substrate 144.

The electrostatic chuck 166 comprises at least one clamping electrode 180 controlled using a chucking power source 182. The electrode 180 (or other electrode disposed in the chuck 166 or base 164) may further be coupled to one or more RF power sources 184, 186 through a matching circuit 188 for maintaining a plasma formed form process and/or other gases within the processing chamber 100. The sources 184, 186 are generally capable of producing an RF signal having a frequency from about 50 kHz to about 3 GHz and a power of up to about 10,000 Watts.

The base 164 is secured to the electrostatic chuck 166 by a adhesive material 136, which may be identical to the adhesive material 122 utilized to bond the gas distribution plate 196 and the conductive base 194 in the gas distribution assembly 130. As described above, the adhesive material 136 facilitates thermal energy exchange between the electrostatic chuck 166 and the base 164 and compensates for the thermal expansion mismatch therebetween. In one exemplary embodiment, the adhesive material 136 mechanically bonds the electrostatic chuck 166 to base 164. It is contemplated that the adhesive material 136 may also be used to bond other parts and/or components utilized to assemble the substrate support assembly 148, such as bonding the base 164 to the mounting plate 162.

FIG. 2 depicts a process flow of a method 200 for debonding chamber components used in a semiconductor processing chamber that are bonded together by an adhesive layer, such as the layers of adhesive material 122, 136 depicted in FIG. 1. The method 200 starts at block 202 by placing bonded chamber components, such as a portion of a gas distribution assembly, in an organic solution. As the adhesive layer used to bond the chamber components are typically organic materials, an organic solution with similar and comparable bonding structure polarity is therefore selected to dissolve, soften, or weaken the bonding structures in the adhesive layer. In one embodiment, the organic solution is selected from at least one of toluene containing solution, xylene containing solution, mixtures thereof, acetone or the like.

At block 204, the bonded chamber component is soaked in the organic solution for a predetermined time period. In one embodiment, the bonded chamber component is soaked in the organic solution for between about 8 hours to about 240 hours, such as between about 24 hours and about 120 hours, such as about 72 hours. After soaking the bonded chamber component for between about 8 hours to about 240 hours, the adhesive layer disposed between the bonded chamber components is dissolved, softened, or weakened sufficiently to allow the bonded chamber components to be readily separated. During soaking, mega-sonic vibration or other suitable energy application techniques, such as thermal energy or the like, may also be applied to the organic solution as needed to assist weakening the adhesive material during soaking.

At block 206, after the chamber component is soaked in the organic solution for the determined time period, the chamber components may be removed from the organic solvent readily to be detached.

At block 208, a tool 302, such as a pin, a feeler gauge, flat stock, rod, wedge, or suitable tool, is used to insert into an interface 308 between a first surface 304 and a second surface 306 of the two bonded chamber components 310, 312, as depicted in FIG. 3. In one example, the two bonded chamber components 310, 312 are the gas distribution plate 194 and the conductive base plate 196 or the base 164 and the electrostatic chuck 166, as described above with referenced to FIG. 1. The tool 302 can assist mechanically separating the first and the second surface 304, 306 detaching from the layer of adhesive material 122 so as to debond the first component 310 from the second component 312. As the layer of adhesive material 122 (or the adhesive material 136) has been softened, dissolved, or weakened by the organic solution soaked at block 204, applying a mechanical force at the interface 308 where the layer of adhesive material 122 (or the adhesive material 136) is disposed, the chamber components 310, 312 can be easily separated without adversely damaging either the first 304 or the second surface 306 at the interface 308. Careful use of the tool 302 while separating the components 310, 312, the first surface 304 and the second surface 306 will retain good surface properties without damage after separation. Accordingly, both debonded chamber components 310, 312 may be reclaimed, reused, or recycled, thereby reducing the cost of ownership while reducing the environmental impact of scrap.

Thus, a method to debond/separate bonded chamber components is provided. The bonded chamber components are debonded by soaking in an organic solution for a predetermined time period. The adhesive material used to bond the chamber components is softened, dissolved, or weakened during the soaking process, thereby facilitating mechanical separation of the chamber components without adversely damaging the bonding interface.

While the foregoing is directed to embodiments of the present invention, other and further embodiments of the invention may be devised without departing from the basic scope thereof, and the scope thereof is determined by the claims that follow.

What is claimed is:

1. A method for debonding chamber components used in a semiconductor processing chamber, comprising:
providing a first chamber component and a second chamber component bonded by an adhesive material disposed at an interface defined between the first and the second chamber components;
soaking the bonded first and the second chamber components in an organic solution for between about 8 hours to about 240 hours;
removing the bonded first and the second chamber from the organic solution; and
mechanically separating the soaked first and the second chamber component.

2. The method of claim 1, wherein soaking further comprises:
soaking the bonded first and the second chamber components for between about 24 hours and about 120 hours.

3. The method of claim 1, wherein mechanically separating further comprising:
inserting a tool between the first and the second chamber components.

4. The method of claim 3, wherein the tool inserted between the first and the second chamber components is a pin, a feeler gauge, a flat stock, a rod or a wedge.

5. The method of claim 1, wherein the organic solution is at least one of toluene containing solution, xylene containing solution, mixtures thereof, or acetone.

6. The method of claim 1, wherein the first chamber component is a gas distribution plate and the second chamber component is a conductive base plate.

7. The method of claim 1, the adhesive material is a silicone based or acrylic based material.

8. The method of claim 1, wherein soaking the bonded first and the second chamber components further comprises:
applying mega-sonic vibration to the organic solution.

9. The method of claim 1, wherein soaking the bonded first and the second chamber components further comprises:
applying thermal energy to the organic solution.

10. The method of claim 1, wherein soaking the bonded first and the second chamber components further comprises:
softening the adhesive layer disposed between the first and the second chamber components.

11. The method of claim 1, wherein the organic solution selected to soak the first and the second chamber components has similar or comparable bonding structure polarity to bonding structures in the adhesive layer.

12. A method for debonding chamber components used in a semiconductor processing chamber, comprising:
providing a first chamber component and a second chamber component bonded by a silicone based or acrylic based adhesive material disposed at an interface defined between the first and the second chamber components;
soaking the bonded first and the second chamber components in an organic solution for between about 8 hours to about 240 hours;
softening the silicone based or acrylic based adhesive layer disposed between the first and the second chamber components;
removing the bonded first and the second chamber from the organic solution; and
mechanically separating the soaked first and the second chamber component.

13. The method of claim 12, wherein mechanically separating further comprising:
inserting a tool between the first and the second chamber components.

14. The method of claim 13, wherein the tool inserted between the first and the second chamber components is a pin, a feeler gauge, a flat stock, a rod or a wedge.

15. The method of claim 12, wherein the organic solution is at least one of toluene containing solution, xylene containing solution, mixtures thereof, or acetone.

16. The method of claim 12, wherein the organic solution selected to soak the first and the second chamber components has similar or comparable bonding structure polarity to bonding structures in the adhesive layer.

17. The method of claim 12, wherein the first chamber component is a gas distribution plate and the second chamber component is a conductive base plate used in an etching chamber.

18. The method of claim 12, wherein soaking the bonded first and the second chamber components further comprises:
applying mega-sonic vibration to the organic solution.

19. The method of claim 12, wherein soaking the bonded first and the second chamber components further comprises:
applying thermal energy to the organic solution.

20. A method for debonding chamber components used in a semiconductor processing chamber, comprising:
providing a first chamber component and a second chamber component bonded by a silicone based or acrylic based adhesive material disposed at an interface defined between the first and the second chamber components;
soaking the bonded first and the second chamber components in an organic solution for between about 8 hours to about 240 hours;
softening the silicone based or acrylic based adhesive layer disposed between the first and the second chamber components;
removing the bonded first and the second chamber from the organic solution selected from at least one of toluene containing solution, xylene containing solution, mixtures thereof, or acetone; and
mechanically separating the soaked first and the second chamber component.
